(19) United States
(12) Patent Application Publication
(10) Pub. No.: US 2026/0050146 A1
(43) Pub. Date: Feb. 19, 2026

(54) MEDIUM TELEPHOTO FULL FRAME LENS

(71) Applicants: Guangdong Sirui Optical Co., Ltd., Zhongshan (CN); Zhongshan AZU Optoelectronics Technology Co., Ltd., Zhongshan (CN)

(72) Inventors: Jie Li, Zhongshan (CN); Kunyi Lin, Zhongshan (CN); Haoer Xing, Zhongshan (CN)

(73) Assignees: Guangdong Sirui Optical Co., Ltd., Zhongshan (CN); Zhongshan AZU Optoelectronics Technology Co., Ltd., Zhongshan (CN)

(21) Appl. No.: 18/938,117

(22) Filed: Nov. 5, 2024

(30) Foreign Application Priority Data
Aug. 15, 2024 (CN) 202411126390.7
Aug. 15, 2024 (CN) 202421987774.3

(51) Int. Cl. G02B 13/02; G02B 7/02; G02B 9/64; G02B 13/00

(52) U.S. Cl. CPC G02B 13/02; G02B 7/025; G02B 9/64; G02B 13/0045; G02B 13/006

(57) ABSTRACT

A medium-long focal length full-frame lens comprises a first lens group, a second lens group, a third lens group, and a fourth lens group arranged in sequence from the object side to the image side along the optical axis. The combined focal length of all lens groups satisfies the following conditional formula: 1.5<f(G1)/f<3.3; 0.7<f(G2−G4)/f<1.5; −1<f(G3)/f(G2−G4)<−0.5; wherein f(G1) is the combined focal length of the first lens group, f(G2−G4) is the combined focal length of the second lens group, the third lens group, and the fourth lens group, f(G3) is the combined focal length of the third lens group, and f is the combined focal length of all lens groups.

### CROSS-REFERENCE TO RELATED APPLICATIONS

This application claims priority to Chinese applications 202411126390.7 and 202421987774.3, both filed on Aug. 15, 2024, whose disclosures are incorporated by reference in their entirety.

### TECHNICAL FIELD

Aspects of the invention generally relate to the technical field of optical lenses, and in particular to a medium-long focal length full-frame lens.

### BACKGROUND

In recent years, although the multi-function of mobile phones has replaced the daily use of compact cameras for photography. In the eyes of photography enthusiasts with higher photography demands, micro single or mirrorless cameras are preferred over mobile phones for better photographic experience. For example, micro single camera lenses have the advantages of being small, lightweight, easy to carry, larger image surface and aperture, and can generally provide better background blur effect.

The existing medium-telephoto full-frame lenses have various aberrations and low resolution problems in imaging some visual bands.

### SUMMARY

Therefore, aspects of the invention attempt to solve or overcome the defects of various aberrations and low resolution in the imaging of some visual bands of medium-long focal length full-frame lenses in the prior art, thereby providing an improved medium-long focal length full-frame lens.

In one embodiment, aspects of the present invention include as follows:

A medium-long focal length full-frame lens, comprising a first lens group, a second lens group, a third lens group, and a fourth lens group arranged in sequence from the object side to the image side along the optical axis: the combined focal length of all lens groups satisfies the following conditional formula:

$$1. 5 < f ( G 1 ) / f < 3.3 ;$$

$$0.7 < f ( G 2 - G 4 ) / f < 1.5 ;$$

$$- 1 < f ( G 3 ) / f ( G 2 - G 4 ) < - 0.5 ;$$

Wherein, f(G1) is the combined focal length of the first lens group, f(G2−G4) is the combined focal length of the second lens group, the third lens group and the fourth lens group, f(G3) is the combined focal length of the third lens group, and f is the combined focal length of all lens groups.

Further, an aperture may be provided between the first lens group and the second lens group, and the third lens group may be moved along the direction of the optical axis to achieve focusing.

Further, in some embodiments, the first lens group may include a first lens, a second lens, a third lens, and a fourth lens arranged in sequence from the object side to the image side along the optical axis.

In some embodiments, the first lens may be a meniscus lens with a positive focal power and a convex surface facing the object surface.

In some embodiments, the second lens may be a meniscus lens with a positive refractive power and a convex surface facing the object surface.

In some embodiments, the third lens may be a meniscus lens with a positive refractive power and a convex surface facing the object surface.

In some embodiments, the fourth lens may be a meniscus lens with a negative refractive power and a convex surface facing the object surface.

Wherein, in some embodiments, the side surfaces of the third lens and the fourth lens may be glued together.

Further, in some embodiments, the second lens group may include a fifth lens, and the fifth lens may be a meniscus lens with a positive refractive power and a convex surface facing the object surface.

Further, in some embodiments, the third lens group may include a sixth lens, and the sixth lens may be a meniscus lens with a negative refractive power and a convex surface facing the object surface.

Further, in some embodiments, the fourth lens group may include a seventh lens, an eighth lens, a ninth lens, a tenth lens, an eleventh lens, a twelfth lens, a thirteenth lens and a fourteenth lens arranged in sequence from the object side to the image side along the optical axis.

In some embodiments, the seventh lens may be a meniscus lens with a negative refractive power and a convex surface facing the object surface.

In some embodiments, the eighth lens may be a meniscus lens with a positive refractive power and a convex surface facing the object surface.

In some embodiments, the ninth lens may be a biconcave lens with a negative refractive power.

In some embodiments, the tenth lens may be a biconvex lens with a positive refractive power.

In some embodiments, the eleventh lens may be a biconvex lens with a positive refractive power.

In some embodiments, the twelfth lens may be a biconcave lens with a negative refractive power.

In some embodiments, the thirteenth lens may be a meniscus lens with a positive refractive power and a convex surface facing the image surface.

In some embodiments, the fourteenth lens may be a biconcave lens with a negative refractive power.

Among them, in some embodiments, the side surfaces of the seventh lens and the eighth lens may be glued together, the side surfaces of the ninth lens and the tenth lens may be glued together, the side surfaces of the eleventh lens and the twelfth lens may be glued together, and the side surfaces of the thirteenth lens and the fourteenth lens may be glued together.

Further, in some embodiments, the object side surfaces facing the object side and the image side surfaces facing the image side of all lenses in the first lens, the second lens, the third lens, the fourth lens, the fifth lens, the sixth lens, the seventh lens, the eighth lens, the ninth lens, the tenth lens, the eleventh lens, the twelfth lens and the fourteenth lens may be spherical surfaces. In some embodiments, the object side surface of the thirteenth lens facing the object side may be aspherical, and the image side surface of the thirteenth lens facing the image side may be spherical.

Further, in some embodiments, the aperture of the medium-telephoto full-frame lens may be 1-1.6, and the focal length of the medium-telephoto full-frame lens is 70-90 mm.

Further, in some embodiments, the total optical length of the medium-telephoto full-frame lens may not exceed 115 mm.

The advantages of the medium-telephoto full-frame lens provided by the aspects of the present invention may include that various aberrations in various visual bands are corrected so that both the center and edge fields of view have sufficient resolution. Further advantages of simple structure, small size, and large aperture may include high resolution imaging at object distances from infinity to close distances.

### BRIEF DESCRIPTION OF THE DRAWINGS

In order to more clearly illustrate the specific embodiments of the present invention or the technical solution in the prior art, the following will briefly introduce the drawings required for the specific implementation or the prior art description. Obviously, the drawings described below are some implementations of the present invention. For those skilled in the art, other drawings may be obtained based on these drawings without creative work.

FIG. 1 is a schematic diagram of the cross-sectional structure of a telephoto full-frame lens according to an embodiment of the present invention;

FIG. 2 is a field curvature distortion diagram of a telephoto full-frame lens according to an embodiment of the present invention.

Reference number keys: G1, first lens group; G2, second lens group; G3, third lens group; G4, fourth lens group; 1, first lens; 2, second lens; 3, third lens; 4, fourth lens; 5, fifth lens; 6, sixth lens; 7, seventh lens; 8, eighth lens; 9, ninth lens; 10, tenth lens; 11, eleventh lens; 12, twelfth lens; 13, thirteenth lens; 14, fourteenth lens.

### DETAILED DESCRIPTION

The technical solution of the aspects of present invention will be described clearly and completely below in conjunction with the accompanying drawings.

Obviously, the described embodiments are part of the embodiments of the present invention, not all of the embodiments. Based on the embodiments of the present invention, all other embodiments obtained by ordinary technicians in the field without creative work are within the scope of protection of the present invention.

In the description of the present invention, it should be noted that the orientation or position relationship indicated by the terms “center”, “up”, “down”, “left”, “right”, “vertical”, “horizontal”, “inside”, “outside”, etc. is based on the orientation or position relationship shown in the accompanying drawings, which is only for the convenience of describing the present invention and simplifying the description, rather than indicating or implying that the device or element referred to must have a specific orientation, be constructed and operated in a specific orientation, and therefore cannot be understood as a limitation of the present invention. In addition, the terms “first”, “second”, and “third” are only used for descriptive purposes and cannot be understood as indicating or implying relative importance.

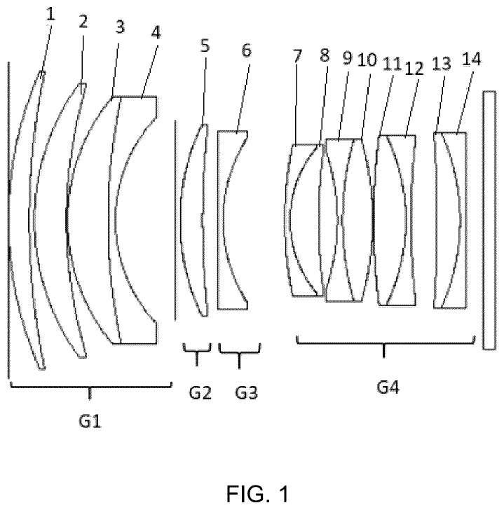

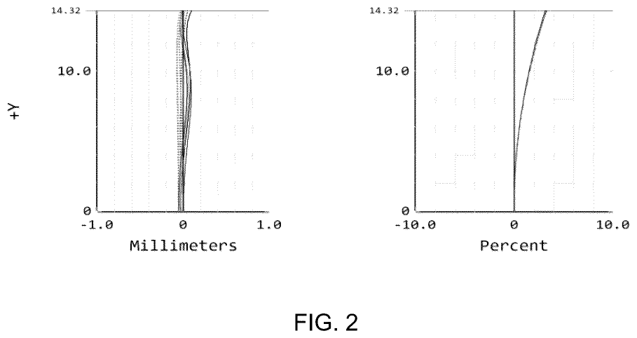

Referring now to FIGS. 1 and 2, a medium-telephoto full-frame lens may include, for example, a first lens group G1, a second lens group G2, a third lens group G3, and a fourth lens group G4 arranged in sequence along the optical axis from the object side to the image side. In one example, the combined focal length of all lens groups satisfies the following conditional formula:

$$1.5 < f ( G 1 ) / f < 3.3 ;$$

$$0.7 < f ( G 2 - G 4 ) / f < 1.5 ;$$

$$- 1 < f ( G 3 ) / f ( G 2 - G 4 ) < - 0.5 ;$$

Wherein, f(G1) is the combined focal length of the first lens group, f(G2−G4) is the combined focal length of the second lens group, the third lens group and the fourth lens group, f(G3) is the combined focal length of the third lens group, and f is the combined focal length of all lens groups.

In one embodiment, in this embodiment, the first lens group G1 may include a first lens 1, a second lens 2, a third lens 3, and a fourth lens 4, which may be arranged in sequence from an object side to an image side along an optical axis. In one example, the first lens 1 may be a meniscus lens with a positive optical power and a convex surface facing the object plane. In some embodiments, the second lens 2 may be a meniscus lens with a positive refractive power and a convex surface facing the object plane. In another example, the third lens 3 may be a meniscus lens with a positive refractive power and a convex surface facing the object plane. In yet another example, the fourth lens 4 may be a meniscus lens with a negative refractive power and a convex surface facing the object plane. In some embodiments, the second lens group G2 may include a fifth lens 5, and the fifth lens 5 may be a meniscus lens with a positive refractive power and a convex surface facing the object plane.

In some embodiments, the third lens group G3 may include a sixth lens 6, and the sixth lens 6 may be a meniscus lens with a negative refractive power and a convex surface facing the object plane. In some embodiments, the fourth lens group G4 may include a seventh lens 7, an eighth lens 8, a ninth lens 9, a tenth lens 10, an eleventh lens 11, a twelfth lens 12, a thirteenth lens 13 and a fourteenth lens 14. In one aspect, the seventh lens 7 may be a meniscus lens with a negative refractive power and a convex surface facing the object plane. In some embodiments, the eighth lens 8 may be a meniscus lens with a positive refractive power and a convex surface facing the object plane. In another aspect, the ninth lens 9 may be a biconcave lens with a negative refractive power. In one other embodiment, the tenth lens 10 may be a biconvex lens with a positive refractive power. In some embodiments, the eleventh lens 11 may be a biconvex lens with a positive refractive power. In some embodiments, the twelfth lens 12 may be a biconcave lens with a negative refractive power. In some embodiments, the thirteenth lens 13 may be a meniscus lens with a positive refractive power and a convex surface facing the image plane; and the fourteenth lens 14 may be a biconcave lens with a negative refractive power.

In some embodiments, the sides of the third lens 3 and the fourth lens 4 may be glued together, and the sides of the seventh lens 7 and the eighth lens 8 may be glued together. In some embodiments, the sides of the ninth lens 9 and the tenth lens 10 may be glued together, and the sides of the eleventh lens 11 and the twelfth lens 12 may be glued together, while the sides of the thirteenth lens and the fourteenth lens 14 may be glued together. In some embodiments, the glued lens combination may effectively correct chromatic aberration and make the color of the captured picture more realistic.

In one embodiment, an aperture may be provided between the first lens group G1 and the second lens group G2, and the third lens group G3 may move along the direction of the optical axis to achieve focusing. In some embodiments, the third lens group G3 may have only a single lens for achieving the focusing function, and the focusing operation may be lighter and simpler.

In some embodiments, the object side surface facing the object side and the image side surface facing the image side of all lenses in the first lens 1, the second lens 2, the third lens 3, the fourth lens 4, the fifth lens 5, the sixth lens 6, the seventh lens 7, the eighth lens 8, the ninth lens 9, the tenth lens 10, the eleventh lens 11, the twelfth lens 12 and the fourteenth lens 14 may be spherical surfaces. In some embodiments, the object side surface of the thirteenth lens 13 facing the object side may be aspherical, and the image side surface of the thirteenth lens 13 facing the image side may be spherical. Such an arrangement may effectively correct aberrations such as spherical aberration and field curvature, and may reduce the overall weight of the lens.

In some embodiments, the aperture of the medium-telephoto full-frame lens may be 1-1.6, and the focal length of the medium-telephoto full-frame lens may be about 70-90 mm. in some embodiments, the total optical length of the medium-telephoto full-frame lens may not exceed 115 mm.

For example, the parameters for each lens are provided in the Table 1 below:

TABLE 1

| | | | | Refractive | Abee |
|---|---|---|---|---|---|
| Lens | Surface | Radius | Depth | Index | Number |
| number | shape | (mm) | (mm) | Nd | (Vd) |
| First lens | Spherical | 64.708 | 4.80 | 1.928 | 18.38 |
| | Spherical | 146.295 | 1.02 | | |
| Second lens | Spherical | 67.274 | 6.87 | 1.529 | 66.58 |
| | Spherical | 88.138 | 0.21 | | |
| Third lens | Spherical | 36.718 | 7.72 | 1.563 | 69.66 |
| Fourth lens | Spherical | 157.150 | 1.47 | 1.901 | 15.98 |
| | Spherical | 35.489 | 12.53 | | |
| Aperture | Spherical | Infinity | 1.34 | | |
| Fifth lens | Spherical | 42.704 | 3.79 | 1.831 | 35.66 |
| | Spherical | 170.162 | 2.87 | | |
| Sixth lens | Spherical | 676.825 | 0.66 | 1.558 | 38.98 |
| | Spherical | 32.242 | 11.30 | | |
| Seventh lens | Spherical | 79.484 | 0.85 | 1.859 | 20.32 |
| Eighth lens | Spherical | 19.923 | 5.99 | 1.533 | 49.47 |
| | Spherical | 65.393 | 3.62 | | |
| Ninth lens | Spherical | −43.130 | 1.09 | 1.617 | 43.88 |
| Tenth lens | Spherical | 60.495 | 5.81 | 2.043 | 14.32 |
| | Spherical | −59.925 | 0.21 | | |
| Eleventh lens | Spherical | 144.127 | 6.33 | 1.804 | 48.44 |
| Twelfth lens | Spherical | −34.702 | 1.00 | 1.608 | 32.52 |
| | Spherical | 137.916 | 5.06 | | |
| Thirteenth lens | Aspheric | −775.521 | 3.82 | 1.864 | 32.71 |
| Fourteenth lens | Spherical | −37.772 | 1.15 | 1.654 | 19.06 |
| | Spherical | 672.557 | 3.34 | | |
| | Spherical | Infinity | 2.71 | 1.517 | 64.20 |
| | Spherical | Infinity | 14.85 | | |

Thirteenth lens' non-coefficients may be shown in Table 2 below:

TABLE 2

| Thirteenth lens | Aspheric |
|---|---|
| K | 0 |
| A4 | −4.19409E−06 |
| A6 | −8.09531E−10 |
| A8 | 5.91892E−12 |
| A10 | −2.3495E−14 |
| A12 | 6.14834E−18 |
| A14 | 2.40936E−20 |

As shown in FIG. 1, in some embodiments, the sixth lens 6 may be focused between the fifth lens 5 and the seventh lens 7 along the direction of the optical axis, so that the overall length of the lens may be kept unchanged when the lens adjusts the focal length.

In some embodiments, the medium-long focal length full-frame lens may correct various aberrations in various visual bands, so that both the center and edge fields of view have sufficient resolution, has the advantages of simple structure, small size, and large aperture, and can achieve high resolution imaging from infinity to close distance.

As may be seen from FIG. 2, in some embodiments, the field curvature of the medium-long focal length full-frame lens on the light in the meridian (corresponding to T in FIG. 2) and sagittal (corresponding to S in FIG. 2) directions may be between −0.2 mm and 0.2 mm. in some embodiments, the maximum distortion of the half-frame lens may be within 10%.

In some embodiments, the medium-long focal length full-frame lens may adopt an integrated design, which realizes the miniaturization of the lens while obtaining excellent cost-effective optical performance such as high resolution, low breathing, and low distortion. It may be designed to match the bayonet of various brands of cameras on the market according to actual use needs to achieve personalized customization and universal matching.

Obviously, the above embodiments are merely examples for the purpose of clear disclosure, and are not intended to limit the implementation. For those skilled in the art, other different forms of changes or modifications may be made based on the above description. It is not necessary and impossible to list all the implementation methods here. The obvious changes or modifications derived therefrom are still within the scope of protection of the invention.

What is claimed is:

1. A medium-long focal length full-frame lens comprising:
a first lens group;
a second lens group;
a third lens group; and
a fourth lens group;
wherein the first lens group, the second lens group, the third lens group and the fourth lens group are arranged in sequence from an object side to an image side along an optical axis;
wherein a combined focal length of the first lens group, the second lens group, the third lens group and the fourth lens group lens groups satisfies the following conditional formula:
$$1.5 < f ( G 1 ) / f < 3.3 ;$$
$$0.7 < f ( G 2 - G 4 ) / f < 1.5 ;$$
$$- 1 < f ( G 3 ) / f ( G 2 - G 4 ) < - 0.5 ;$$
wherein f(G1) comprises a combined focal length of the first lens group,
wherein f(G2−G4) comprises a combined focal length of the second lens group, the third lens group, and the fourth lens group,
wherein f(G3) comprises a combined focal length of the third lens group, and f comprises the combined focal length of the first lens group, the second lens group, the third lens group and the fourth lens group.

2. The medium-long focal length full-frame lens according to claim 1, wherein an aperture is disposed between the first lens group (G1) and the second lens group (G2), and wherein the third lens group (G3) is configured to move along a direction of the optical axis.

3. The medium-long focal length full-frame lens according to claim 1, wherein the first lens group (G1) comprises a first lens (1), a second lens (2), a third lens (3), and a fourth lens (4) arranged in sequence from the object side to the image side along the optical axis;
wherein the first lens (1) comprises a positive focal length meniscus lens with a convex surface facing the object surface;
wherein the second lens (2) comprises a positive refractive power meniscus lens with a convex surface facing the object surface;
wherein the third lens (3) comprises a positive refractive power meniscus lens with a convex surface facing the object surface;
wherein the fourth lens (4) comprises a negative refractive power meniscus lens with a convex surface facing the object surface; and
wherein sides of the third lens (3) and the fourth lens (4) are glued together.

4. The medium-telephoto full-frame lens according to claim 1,
wherein the second lens group (G2) comprises a fifth lens (5); and
wherein the fifth lens (5) comprises a positive meniscus lens with a convex surface facing the object plane.

5. The medium-telephoto full-frame lens according to claim 1,
wherein the third lens group (G3) comprises a sixth lens (6); and
wherein the sixth lens (6) comprises a negative meniscus lens with a convex surface facing the object plane.

6. The medium-telephoto full-frame lens of claim 3,
wherein the fourth lens group (G4) comprises a seventh lens (7), an eighth lens (8), a ninth lens (9), a tenth lens (10), an eleventh lens (11), a twelfth lens (12), a thirteenth lens (13) and a fourteenth lens (14) arranged in sequence along the optical axis from the object side to the image side;
wherein the seventh lens (7) comprises a meniscus lens with a negative refractive power and a convex surface facing an object plane;
wherein the eighth lens (8) comprises a meniscus lens with a positive refractive power and a convex surface facing the object plane;
wherein the ninth lens (9) comprises a biconcave lens with a negative refractive power;
wherein the tenth lens (10) comprises a biconvex lens with a positive refractive power;
wherein the eleventh lens (11) comprises a biconvex lens with positive refractive power;
wherein the twelfth lens (12) comprises a biconcave lens with negative refractive power;
wherein the thirteenth lens (13) comprises a meniscus lens with positive refractive power and the convex surface faces an image plane;
wherein the fourteenth lens (14) comprises a biconcave lens with negative refractive power;
wherein side surfaces of the seventh lens (7) and the eighth lens (8) are glued together,
wherein side surfaces of the ninth lens (9) and the tenth lens (10) are glued together,
wherein side surfaces of the eleventh lens (11) and the twelfth lens (12) are glued together, and
wherein side surfaces of the thirteenth lens and the fourteenth lens (14) are glued together.

7. The medium-long focal length full-frame lens according to claim 6, wherein the object side surface facing the object side and the image side surface facing the image side of all lenses in the first lens (1), the second lens (2), the third lens (3), the fourth lens (4), the fifth lens (5), the sixth lens (6), the seventh lens (7), the eighth lens (8), the ninth lens (9), the tenth lens (10), the eleventh lens (11), the twelfth lens (12) and the fourteenth lens (14) comprise spherical surfaces;
wherein an object side surface of the thirteenth lens (13) facing the object side comprises an aspherical surface, and an image side surface of the thirteenth lens (13) facing an image side is a spherical surface.

8. The medium-long focal length full-frame lens according to claim 1, wherein the aperture comprises 1-1.6, and wherein a focal length comprises 70-90 mm.

9. The medium-long focal length full-frame lens according to claim 1, wherein a total optical length is less than 115 mm.
